(19) United States
(12) Patent Application Publication
(10) Pub. No.: US 2021/0238918 A1
(43) Pub. Date: Aug. 5, 2021

(54) COVERING FOR AN ARCHITECTURAL STRUCTURE WITH INTERNAL RAIL STORAGE FOR ADJUSTING THE COVERING'S DROP LENGTH AND RELATED METHODS

(71) Applicant: Levolor, Inc., Atlanta, GA (US)

(72) Inventors: Jeffrey Travis Stout, Sandy Springs, GA (US); Alberto Alexander Gonzalez, Lawrenceville, GA (US); Justin Lin Zhu, Lawrenceville, GA (US); Kevin Macaraeg Daffon, Marietta, GA (US)

(73) Assignee: Levolor, Inc.

(21) Appl. No.: 17/159,568

(22) Filed: Jan. 27, 2021

Related U.S. Application Data
(60) Provisional application No. 62/967,637, filed on Jan. 30, 2020.

(51) Int. Cl. E06B 9/262; E06B 9/322

(52) U.S. Cl. CPC E06B 9/262; E06B 2009/2622; E06B 2009/2625; E06B 9/322

(57) ABSTRACT

In one aspect, a covering for an architectural structure includes first and second rails and a cellular blanket extending between the first and second rails. One of the first rail or the second rail defines an interior storage cavity for receiving a portion of the cellular blanket to allow a drop length of the covering to be adjusted.

### CROSS-REFERENCE TO RELATED APPLICATIONS

The present application is based upon and claims the right of priority to U.S. Provisional Patent Application No. 62/967,637, filed Jan. 30, 2020, the disclosure of which is hereby incorporated by reference herein in its entirety for all purposes.

### FIELD

The present disclosure relates generally to coverings for architectural structures and, more particularly, to a covering, such as a cellular covering, with internal rail storage for adjusting a drop length of the covering, as well as related methods.

### BACKGROUND

A covering for an architectural structure, such as a blind or shade for a window or door, typically includes a head rail, a bottom rail, one or more covering elements extending between the head rail and the bottom rail, and at least two lift cords extending from the head rail to the bottom rail to suspend the bottom rail relative to the headrail. The vertical distance across which the covering element(s) extends between the headrail and the bottom rail when the covering is at the fully extended position is often referred to as the “drop length” of the covering.

In general, when installing a covering relative to an adjacent architectural structure, it is desirable for the drop length of the covering to generally match the vertical height of the portion of the architectural structure to be covered, such as the vertical height of the interior space defined by a window frame when inside mounting a covering relative to such frame. However, coverings are typically manufactured to have one of several predetermined or standard drop lengths. Unfortunately, the vertical distance across which a covering must extend relative to a given architectural structure is not always equal to the standard drop length(s) provided for a pre-assembled covering. In such instances, the purchaser or consumer typically selects the covering with the closest drop length that exceeds the vertical distance to be covered. As a result, excessive material is often present at the bottom of the covering element when the covering is fully extended relative to the architectural structure. For instance, with a cellular shade, the excess cells of the cellular blanket will bunch or stack together at the bottom of the window frame when the drop length of the shade exceeds the corresponding vertical height of the window frame, resulting in an undesirable aesthetic or appearance for the shade.

Accordingly, a covering with internal rail storage for quickly and easily adjusting the drop length of the covering would be welcomed in the technology.

### BRIEF DESCRIPTION

Aspects and advantages of the present disclosure will be set forth in part in the following description, or may be obvious from the description, or may be learned through practice of the present disclosure.

In one aspect, the present subject matter is directed to a covering for an architectural structure that includes a headrail having a first lateral end and a second lateral end opposite the first lateral end, with the headrail defining an interior storage cavity extending in a lateral direction between the first and second lateral ends of the headrail. The covering also includes a bottom rail suspended relative to the headrail, and a cellular blanket coupled to the headrail. The cellular blanket includes an upper section, a lower section, and a plurality of vertically aligned cells, with a first portion of the vertically aligned cells being included within the upper section of the cellular blanket and a second portion of the vertically aligned cells being included within the lower section of the cellular blanket. The lower section of the cellular blanket extends between the headrail and the bottom rail such that the lower section of cellular blanket defines a drop length of the covering when in an extended position. Additionally, the upper section of the cellular blanket is received within the interior storage cavity of the headrail, and a number of the plurality of vertically aligned cells included within the upper section of the cellular blanket is adjustable to vary the drop length of the covering when in the extended position.

In another aspect, the present subject matter is directed to a covering for an architectural structure. The covering includes first and second rails and a cellular blanket extending between the first and second rails. The cellular blanket includes, a first section, a second section, and a plurality of vertically aligned cells, with a first portion of the vertically aligned cells being included within the first section of the cellular blanket and a second portion of the vertically aligned cells being included within the second section of the cellular blanket. The first section of the cellular blanket is received within an interior storage cavity defined by the first rail and the interior storage cavity is sized such that at least 20% of the vertically aligned cells of the cellular blanket are configured to be received therein. Additionally, the second section of the cellular blanket extends between the first and second rails such that the second section of the cellular blanket defines a drop length of the covering when in an extended position, and a number of the vertically aligned cells included within the first section of the cellular blanket is adjustable to vary the drop length of the covering when in the extended position.

In a further aspect, the present subject matter is directed to a method for adjusting a drop length of a covering for an architectural structure. The covering includes a headrail, a bottom rail, and a cellular blanket, with an initial drop length of the covering being defined across a plurality of vertically aligned cells of the cellular blanket extending between the headrail and the bottom rail. The method includes decoupling the headrail from the cellular blanket and forming a collapsed stack of cells from a portion of the plurality of vertically aligned cells included within an upper section of the cellular blanket. The method also includes reinstalling the headrail relative to the cellular blanket such that the collapsed stack of cells is received within an interior storage cavity of the headrail and a lower section of the cellular blanket including a remainder of the plurality of vertically aligned cells extends between the headrail and the bottom rail to define an adjusted drop length for the covering that differs from the initial drop length.

These and other features, aspects and advantages of the present disclosure will become better understood with reference to the following Detailed Description and appended claims. The accompanying drawings, which are incorporated in and constitute a part of this specification, illustrate embodiments of the present disclosure and, together with the description, serve to explain the principles of the present disclosure.

This Brief Description is provided to introduce a selection of concepts in a simplified form that are further described below in the Detailed Description. This Brief Description is not intended to identify key features or essential features of the claimed subject matter, nor is it intended as an aid in determining the scope of the claimed subject matter.

### BRIEF DESCRIPTION OF THE DRAWINGS

A full and enabling disclosure of the present subject matter, including the best mode thereof, directed to one of ordinary skill in the art, is set forth in the specification, which makes reference to the appended figures, in which:

FIG. 1 illustrates a perspective view of one embodiment of a covering for an architectural structure in accordance with aspects of the present subject matter;

FIG. 2 illustrates a cross-sectional view of the covering shown in FIG. 1 taken about line 2-2;

FIGS. 3-5 illustrate similar cross-sectional views of the covering shown in FIG. 2, particularly illustrating different amounts of a cellular blanket of the covering stored within a headrail of the covering to adjust the associated drop length of the covering;

FIG. 6 illustrates a perspective view of the covering shown in FIGS. 1 and 2 with the headrail decoupled from or disassembled relative to the cellular blanket in accordance with aspects of the present subject matter;

FIG. 7 illustrates a perspective view of the cellular blanket shown in FIG. 6 after the cells of an upper section of the cellular blanket have been flattened to form a collapsed stack of cells at the top end of the blanket; and

FIG. 8 illustrates a partial perspective view of the cellular blanket shown in FIG. 7 and the headrail of the disclosed covering as the headrail is being reinstalled relative to the cellular blanket to allow the collapsed stack of cells to be received within an internal storage cavity of the headrail.

### DETAILED DESCRIPTION

In general, the present subject matter is directed to a covering for an architectural feature or structure (referred to herein simply as an architectural “structure” for the sake of convenience without intent to limit), such as a window or door, that includes internal rail storage for receiving a portion of the covering material extending between a headrail and a bottom rail of the covering, thereby allowing the drop length of the covering to be adjusted. Specifically, in several embodiments, the covering may be configured as a cellular covering including a cellular panel or blanket extending between the headrail and the bottom rail, with the cellular blanket defining or including a plurality of vertically aligned cells (e.g., honeycomb cells). In accordance with aspects of the present subject matter, a portion of the cellular blanket may be configured to be received within internal rail storage defined by one of the headrail or the bottom rail when it is desired to shorten the drop length of the covering. Similarly, when it is desired to increase the drop length of the covering, a portion of the cellular blanket may be removed from the internal rail storage and allowed to extend between the headrail and the bottom rail.

In several embodiments, the internal rail storage may be defined in the headrail of the covering. For instance, in one embodiment, the operating system components of the covering, such as components of the lift system, may be housed primarily or entirely within the bottom rail, thereby providing open storage space within the headrail for allowing a portion of the cellular blanket to be received therein. In such an embodiment, to shorten the drop length of the covering, the cellular blanket may be temporarily decoupled from the headrail, such as by sliding the headrail (or the cellular blanket) laterally relative to the cellular blanket (or the headrail) to de-couple such components. An upper portion of the cellular blanket encompassing the number of cells across which it is desired to shorten the drop length may then be flattened or collapsed into a collapsed stack (e.g., by transitioning the associated cells into a collapsed state) to allow such collapsed stack of cells to be received within the internal storage space defined by the headrail. For instance, the headrail may be aligned relative to the collapsed stack of cells to allow the stack to be received within the internal rail storage as the headrail (or the cellular blanket) is moved laterally relative to the cellular blanket (or the headrail) to reassemble the components back together. In such instance, the drop length of the covering will be defined across the remaining portion of the cellular blanket that extends between the headrail and the bottom rail.

It should be appreciated that, in an alternative embodiment, the internal rail storage may be defined by the bottom rail as opposed to the headrail. In such an embodiment, the operating system components of the covering, such as components of the lift system, may be housed primarily or entirely within the headrail, thereby providing open storage space within the bottom rail for allowing a portion of the cellular blanket to be received therein for adjusting the drop length of the covering.

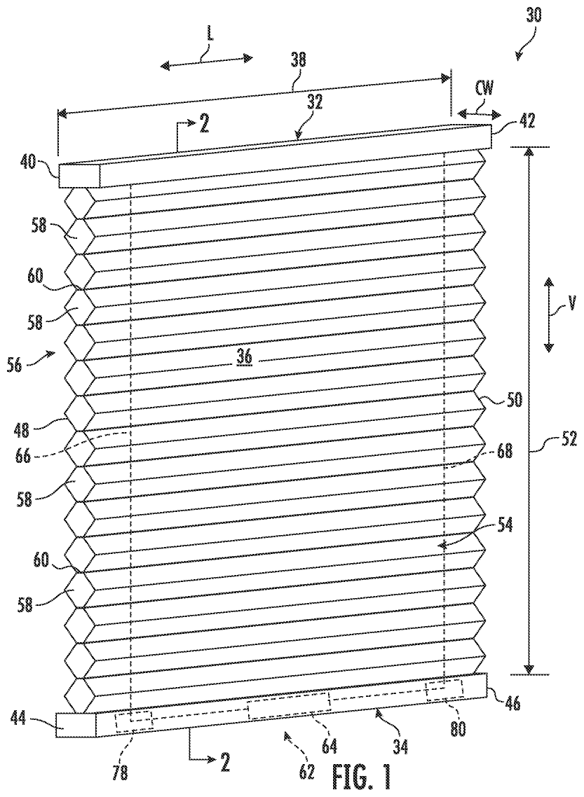

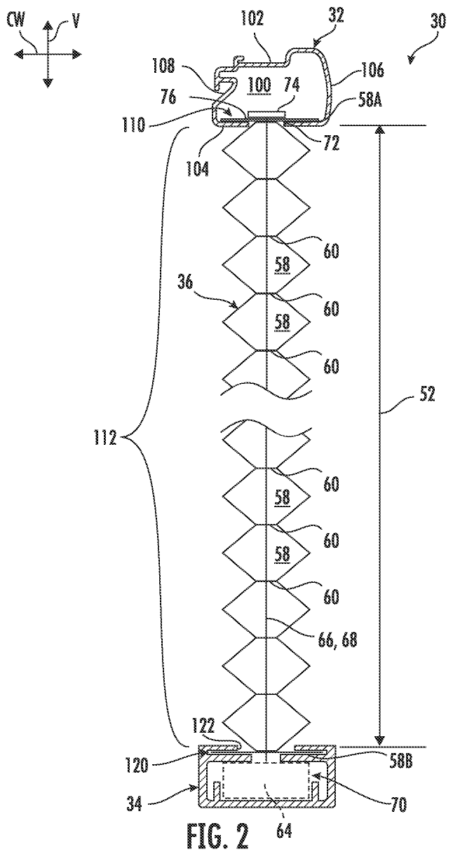

Referring now to the drawings, FIGS. 1 and 2 illustrate different views of one embodiment of a covering 30 for an architectural structure in accordance with aspects of the present subject matter. Specifically, FIG. 1 illustrates a perspective view of the covering 30 and FIG. 2 illustrates a cross-sectional view of the covering 30 shown in FIG. 1 taken about line 2-2. In general, the covering 30 may be configured to be installed relative to a window, door, or any other suitable architectural structure as may be desired. In one embodiment, the covering 30 may be configured to be mounted relative to an architectural structure to allow the covering 30 to be suspended or supported relative to the architectural structure. It should be understood that the covering 30 is not limited in its particular use as a window or door shade, and may be used in any application as a covering, partition, shade, and/or the like, relative to and/or within any type of architectural structure.

In several embodiments, the covering 30 may be configured as a horizontal-type, extendable/retractable cellular covering. For example, in the embodiment shown in FIGS. 1 and 2, the covering 30 includes a headrail 32, a bottom rail 34, and a cellular covering element (e.g., a cellular panel or blanket 36) extending between the headrail 32 and the bottom rail 34. As shown, the headrail 32 and the bottom rail 34 extend in a longitudinal or lateral direction of the covering 30 (as indicated by arrow L in FIG. 1) across a lateral width 38 of the covering 30. Specifically, the headrail 32 extends laterally between a first lateral end 40 of the headrail 32 and a second lateral end 42 of the headrail 32. Similarly, the bottom rail 34 extends laterally between a first lateral end 44 of the bottom rail 34 and a second lateral end 46 of the bottom rail 34. Additionally, the cellular blanket 36 is generally configured to extend in the lateral direction L across the lateral width 38 of the covering 30 (e.g., between opposed first and second lateral sides 48, 50 of the blanket 36) and in a vertical direction of the covering 30 (as indicated by arrow V in FIGS. 1 and 2) between the headrail 32 and the bottom rail 34. In this regard, the vertical height of the cellular blanket 36 defined between the headrail 32 and the bottom rail 34 when the covering 30 is in the fully extended position (e.g., as shown in FIGS. 1 and 2) generally defines a drop length 52 of the covering 30 in the vertical direction V. Additionally, the cellular blanket 36 may also define a front side 54 and a rear side 56 spaced apart from each other along a crosswise direction CW of the covering 30 (as indicated by arrow CW in FIGS. 1 and 2)

It should be appreciated that the cellular blanket 36 may generally have any suitable configuration that allows it to form a cellular-type covering element. For instance, in the illustrated embodiment, the cellular blanket 36 includes a plurality of vertically aligned cells 58, with the cells 58 being stacked or joined one on top of the other to form the vertically extending panel or blanket 36. Specifically, as shown in FIG. 2, each cell 58 may be coupled to or intersect with an adjacent cell 58 at a junction line defined between the adjacent cells 58. In this regard, when each cell 58 is formed from one or more separate strips of material (e.g., a single strip of material forming the entire cell 58 or first and second strips of material forming the opposed front and rear sides of each cell 58, respectively), the strip(s) of material forming such cell 58 may be coupled to the strip(s) of material forming the adjacent cell 58 (e.g., via an adhesive, sewing, ultrasonic welding, etc.) at the adjacent junction line 60. However, in other embodiments, the individual cells 58 of the cellular blanket 36 may be formed in any other suitable manner, such as by forming the opposed front and rear sides 54, 56 of the cellular blanket 36 by front and rear continuous panels coupled to each other at the junction lines 60 to form the cells 58. Additionally, in the illustrated embodiment, the cells 58 of the cellular blanket 36 generally define a honeycomb or hexagonal shape. However, in alternative embodiments, the cells 58 may define any other suitable shape, such as a pentagonal shape. It should also be appreciated that, although the cellular blanket 36 is shown as including a single column of vertically aligned cells 58, the blanket 36 may, instead, include two or more columns of vertically aligned cells.

Additionally, in several embodiments, the covering 30 may include a lift system 62 for moving the covering 30 in the vertical direction V between a lowered or fully extended position (e.g., as shown in FIGS. 1 and 2), at which the bottom rail 34 is spaced apart vertically from the headrail 32 by the covering's drop length 52, and a raised or fully retracted position, at which the bottom rail 34 is positioned generally adjacent to the headrail 32 (less the collapsed or flattened cellular blanket 36 extended therebetween). In general, the lift system 62 may include a plurality of lift system components (shown in FIG. 1 in dashed lines), such as a lifting device or motor assembly 64 (referred to hereinafter simply as a “motor” for purposes of simplicity and without intent to limit) and at least two lift cords coupled to or otherwise provided in operative association with the motor 64. For instance, in the illustrated embodiment, the lift system 62 includes a pair of lift cords (e.g., a first lift cord 66 and a second lift cord 68), with each lift cord 66, 68 being coupled to the motor 64 and extending between the headrail 32 and the bottom rail 34 to allow the bottom rail 34 to be raised and lowered relative to the headrail 32 to move the covering 30 between the retracted and extended positions, respectively. However, it should be appreciated that, depending on the lateral width 38 of the covering 30, the lift system 62 may include additional lift cords. For instance, for wider coverings, the lift system 62 may include four, six or more lift cords extending between the headrail 32 and bottom rail 34, with the various lift cords being spaced apart from one another across the lateral width 38 of the covering 30.

It should be appreciated that the motor 64 may generally have any suitable configuration. In one embodiment, the motor 64 may be configured as a spring motor. In such an embodiment, the motor 64 may, for example, including an outer housing (not shown) encasing or surrounding a spring motor element (not shown). The spring motor element may, in turn, be coupled to lift spools (not shown) (e.g., positioned within the housing) to allow the spring motor element to drive the lift spools when the covering 30 is being moved (e.g., towards the extended position). For instance, the spring motor element may be coupled to the lift spools via a lift rod (not shown) or similar drive rod or shaft.

In the illustrated embodiment, the motor 64 is housed or positioned within the bottom rail 34. For instance, as particularly shown in FIG. 2, the motor 64 is positioned within a motor cavity 70 defined within the bottom rail 34 that extends between the opposed lateral ends 44, 46 of the rail 34. In such an embodiment, each lift cord 66, 68 may be configured to extend laterally from the motor 64 towards a respective lateral end 44, 46 of the bottom rail 34 before exiting the rail 34 and extending vertically upwardly towards the headrail 32. Additionally, each lift cord 66, 68 may be coupled to the headrail 32 or a component positioned within the headrail 32 to allow the bottom rail 34 to be suspended relative thereto via the lift cords 66, 68. For instance, as shown in FIG. 2, each lift cord 66, 68 may extend through a downwardly-facing, laterally extending slot 72 defined in the headrail 32 to allow the end of each lift cord 66, 68 to be coupled or tied to a retention element (e.g., a washer 74) located within the headrail 32, which, in turn, engages a top end 76 of the cellular blanket 36 positioned within the headrail 32 to retain the lift cord 66, 68 relative to both the blanket 36 and the headrail 32. Alternatively, the lift cords 66, 68 may be retained relative to the headrail 32 in any other manner and/or using any other suitable means, such as by tying the lift cords 66, 68 to each other within the interior of the headrail 32 and/or wrapping the cords 66, 68 around a component within the headrail 32.

As particularly shown in FIG. 1, the lift system 62 also includes first and second turn-up or cord cradles 78, 80 provided within the bottom rail 34 (e.g., within the motor cavity 70) adjacent to the first and second lateral ends 44, 46 of the rail 34, respectively, to assist in guiding each lift cord 66, 68 as it transitions or “turns-up” from a laterally-extending orientation within the bottom rail 34 to a vertically-extending orientation. For instance, each cord cradle 78, 80 may include one or more components (e.g., a guide pin(s) and/or roller(s)) positioned at the location at which the associated lift cord 66, 68 turns vertically upward towards the headrail 32, thereby reducing the amount of friction and noise associated with operation of the covering 30 as the lift cords 66, 68 pass by such locations during extension and retraction of the covering 30.

Additionally, in accordance with aspects of the present subject matter, the headrail 32 and/or the bottom rail 34 may define interior rail storage for receiving a portion of the cellular blanket 36, thereby allowing the drop length 52 of the covering 30 to be adjusted as desired. For instance, as particularly shown in the illustrated embodiment, the headrail 32 is configured as a hollow body or rail defining an interior storage cavity 100 extending in the vertical direction V between a top wall 102 and a bottom wall 104 of the headrail 32 and in the crosswise direction CW between front and rear walls 106, 108 of the headrail 32. Additionally, the interior storage cavity 100 generally extends laterally between the opposed lateral ends 44, 46 (FIG. 1) of the headrail 32. As will be described in greater detail below, the storage spaced defined by the interior storage cavity 100 may allow for a substantial portion of the cellular blanket 36 to be received or stored within the headrail 32, as desired, to shorten the overall drop length 52 of the covering 30. Specifically, in several embodiments, an upper section 110 of the cellular blanket 36 may be configured to be received within the interior storage cavity 100 of the headrail 32, while a lower section 112 of the cellular blanket 36 may be positioned exterior of the headrail 32 and extend between the headrail 32 and the bottom rail 34 to define the drop length 52 of the covering 30. As shown in FIG. 2, the upper section 110 of the cellular blanket 36 received within the interior storage cavity 100 may, in one embodiment, encompass or include a minimal amount of cells 58 of the cellular blanket 36 when the covering 30 defines its maximum drop length (e.g., the drop length 52 shown in FIG. 2), such as a single, collapsed uppermost cell 58A of the blanket 36. However, by collapsing additional cells 58 of the cellular blanket 36 into a flattened or collapsed stack for receipt within the headrail 32, the drop length 52 of the covering 30 may be reduced from such maximum drop length.

Moreover, in several embodiments, the bottom rail 34 may also define interior rail storage for receiving a portion of the cellular blanket 36. For instance, as particularly shown in the illustrated embodiment of FIG. 2, the bottom rail 34 defines an interior storage cavity 120 positioned above the motor cavity 70 and being open to an upwardly-facing, laterally extending slot 122 defined in the top of the bottom rail 34 to allow a portion of the cellular blanket 36 to be received therein. In the illustrated embodiment, a single, collapsed lowermost cell 58B of the cellular blanket 36 is received within the storage cavity 120 of the bottom rail 34. However, in other embodiments, a larger portion of the cellular blanket 36 may be received within the storage cavity 120 defined by the bottom rail 34.

It should be appreciated that, given the configuration of the covering 30 shown in FIGS. 1 and 2 (i.e., with the lift system components being positioned within the bottom rail 34 and the headrail 32 being free of such components, less the top ends of the lift cords 66, 68), the interior storage cavity 100 of the headrail 32 is generally configured to receive additional collapsed cells 58 of the cellular blanket 36 (beyond just the uppermost cell 58A) to reduce or shorten the drop length 52 of the covering 30. For instance, as will be described in greater detail below, the configuration of the covering shown in FIGS. 1 and 2 may allow the headrail 32 to be decoupled or disassembled from the cellular blanket 36 (e.g., by sliding the headrail 32 or the blanket 36 in the lateral direction L relative to the other component) without impacting or interfering with the covering's operating system, namely the lift system 62. However, in other embodiments, the lift system components may, instead, be positioned within the headrail 32 such that the bottom rail 34 is free of such components (less the bottom ends of the lift cords 66, 68) and generally comprises a hollow body or rail. In such embodiments, the interior storage cavity 120 of the bottom rail 34 may, for example, be expanded to encompass the motor cavity 70 to provide additional storage space for receiving a larger portion of the cellular blanket 36. With this alternative configuration, the bottom rail 34 may be configured to be decoupled or disassembled from the cellular blanket 36 (e.g., by sliding the bottom rail 34 or the blanket 36 in the lateral direction L relative to the other component) to allow additional collapsed cells 58 of the cellular blanket 36 (beyond just the lowermost cell 58B) to be received within the bottom rail 34 without impacting or interfering with the covering's operating system

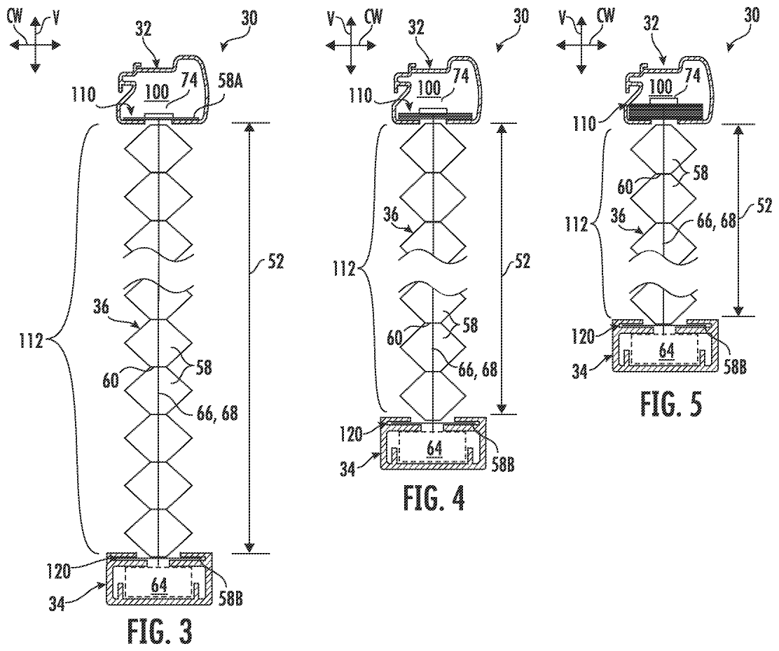

Referring now to FIGS. 3-5, several cross-sectional views of the covering 30 shown in FIGS. 1 and 2 are illustrated with different amounts or percentages of the cellular blanket 36 stored within the interior rail storage of the headrail 32 in accordance with aspects of the present subject matter. Specifically, FIG. 3 illustrates the upper section 110 of the cellular blanket 36 (i.e., the portion of the blanket 36 positioned within the headrail 32) as only encompassing or including a nominal or minimal portion of the cellular blanket 36 such that the drop length 52 of the covering (as defined by the lower section 112 of the blanket 36) is maximized when the covering 30 is at the fully extended position. For instance, in one embodiment, the maximum drop length may be defined when only the uppermost cell 58A of the cellular blanket 36 is positioned within the interior storage cavity 100.

As indicated above, to reduce or shorten the drop length 52 of the covering 34, the covering 30 may be reconfigured such that an additional portion or percentage of the cellular blanket 36 (i.e., additional cells 58 of the blanket 36) is positioned within the interior storage cavity 100 of the headrail 32, thereby reducing the vertical height of the remaining portion of the cellular blanket 36 extending between the headrail 32 and the bottom rail 34 (i.e., the lower section 112 of the blanket 36). For instance, FIG. 4 illustrates the covering 30 with a larger percentage of the cells 58 of the cellular blanket 36 (e.g., 25% of the cells 58) forming the upper section 110 of the cellular blanket 36 and being positioned within the headrail 32 (as compared to the configuration shown in FIG. 3), which results in a reduced drop length 52 of the covering 30 when at the fully extended position (e.g., a reduction of 25% of the maximum drop length). Similarly, FIG. 5 illustrates the covering 30 with an even larger percentage of the cells 58 of the cellular blanket 36 (e.g., 50% of the cells 58) forming the upper section 110 of the cellular blanket 36 positioned within the headrail 32 (as compared to the configuration shown in FIG. 4), which results in a further reduced drop length 52 of the covering 30 when at the fully extended position (e.g., a reduction of 50% of the maximum drop length).

It should be appreciated that the vertical range of drop lengths 52 that may be achieved with the disclosed covering 30 will generally vary based on the number or percentage of the cells 58 of the cellular blanket 36 that can be received within the interior storage of the headrail 32, which, in turn, may depend on the overall size of the storage cavity 100, the size of the cells 58, and the thickness of the blanket material forming the cell walls, among other things. By sizing the interior storage cavity 100 of the headrail 32 to accommodate a larger percentage of the cells 58 of the cellular blanket 36, a larger range of vertical drop lengths 52 can be achieved. In this regard, the interior storage cavity 100 of the headrail 32 may generally be sized or configured such that any suitable percentage of the cells 58 of the cellular blanket 36 can be stored within the headrail 32, thereby allowing a corresponding percent reduction in the maximum drop length to be achieved when the covering 30 is at the fully extended position. In a particular embodiment, the interior storage cavity 100 of the headrail 32 may be sized or configured such that at least 20% of the cells 58 of the cellular blanket 36 can be stored within the headrail 32, thereby allowing at least a 20% reduction in the maximum drop length to be achieved when the covering 30 is at the fully extended position. For instance, the interior storage cavity 100 may be sized or configured such that the maximum percentage of the cellular blanket 36 that can be stored within the headrail 32 ranges from greater than 20% of the cells 58 to less than 90% of the cells 58 or from greater than 20% of the cells 58 to less than 75% of the cells 58 or from greater than 20% of the cells 58 to less than 60% of the cells 58 or from greater than 20% of the cells 58 to less than 50% of the cells 58.

As an example, it may be assumed that the cellular blanket 36 of FIG. 3 includes seventy-two cells forming the lower section 112 of the blanket 36 extending between the headrail 32 and the bottom rail 34, with the covering 30 defining a maximum drop length of seventy-two inches when in the fully extended position (assuming that each cell 58 defines a vertical height of one inch when extended for purposes of the present example). In such instance, if it is desired to shorten the drop length 52 of the covering 30 by a given vertical distance or height, the number of cells 58 that should be moved or transitioned from the lower section 112 of the blanket 36 to the upper section 110 of the blanket 36 for storage within the internal rail cavity 100 of the headrail 32 may be easily determined. For instance, if it is desired to reduce the drop length 52 by 50% (e.g., to thirty-six inches), the covering 30 can be re-configured such that one-half or 50% of the cells 58 of the cellular blanket 36 (e.g., thirty-six cells) are stored within the internal rail storage, with the remaining cells 58 forming the lower section 112 of the blanket 36 (e.g., thirty-six cells) being allowed to extend between the headrail 32 and the bottom rail 34. Similarly, if it is desired to reduce the drop length 52 by ten inches, the covering 30 can be re-configured such that five cells 58 of the cellular blanket 36 are received within the internal rail storage, with the remaining cells 58 forming the lower section 112 of the blanket 36 (e.g., sixty-seven cells) being allowed to extend between the headrail 32 and the bottom rail 34.

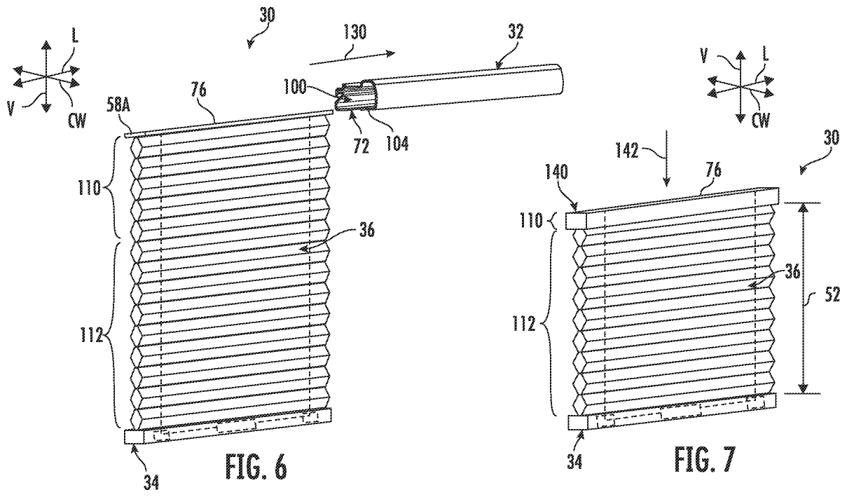

A method for adjusting (e.g., reducing) the drop length of a covering will now be described with reference to FIGS. 6-8. In general, the method will be described with reference to the covering 30 shown in FIGS. 1 and 2. For instance, FIGS. 6-8 illustrate components of the covering 30 in different stages of the drop length adjustment process. However, in other embodiments, it should be appreciated that the method described herein may generally be utilized to adjust the drop length of a covering having any suitable covering configuration.

As an initial step or method element, the method includes disassembling or decoupling the headrail 32 from the remainder of the covering 30. For instance, FIG. 6 illustrates the headrail 32 as it is being disassembled or decoupled from the adjacent cellular blanket 36 of the covering 30. Specifically, as indicated above with reference to FIG. 2, the headrail 32 includes a downward facing, laterally extending slot 72 defined in the bottom wall 104 of the headrail 32 through which the lift cords 66, 68 and a portion of the cellular blanket 36 extend (e.g., to allow the upper section 110 of the blanket 36 to be positioned within the headrail 32). As a result, to disassemble or decouple the headrail 32 from the cellular blanket 36, one of such components (e.g., the headrail 32) may be moved or slid laterally relative to the other component (e.g., the cellular blanket 36). For instance, as shown in FIG. 6, the headrail 32 has been moved or slid relative to the cellular blanket 36 in a first lateral direction (e.g., as indicated by arrow 130 in FIG. 6) to decouple or disassemble the headrail 32 from the cellular blanket 36. During such movement of the headrail 32 relative to the cellular blanket 36, the bottom wall 104 of the headrail 32 may generally be slid or moved along the junction line 60 (FIG. 2) defined between the lowermost cell 58 positioned within the headrail 32 and the next adjacent cell 58 positioned bellow the headrail 32.

Upon decoupling or disassembling the headrail 32 from the cellular blanket 36, the method includes collapsing or flattening a portion of the cells 58 of the cellular blanket 36 to form a collapsed stack of cells 140 at the top end 76 of the blanket 36. For instance, as shown in FIG. 7, the cells 58 of an upper section 110 (FIG. 6) of the cellular blanket 36 have been collapsed or flattened down (e.g., in vertical direction indicated by arrow 142 shown in FIG. 7) to form a collapsed stack of cells 140 at the top end 76 of the blanket 36, with the remainder of the cells 58 (e.g., the cells 58 of lower section 112 of the cellular blanket 36) remaining in the extended or expanded state. As a result, when the collapsed stack of cells 140 is installed within the headrail 32, the covering 30 will define a reduced drop length 52 generally corresponding to the vertical height of the lower section 112 of the cellular blanket 36 when the cells 58 of such lower section 112 are at the fully extended position. Stated differently, the covering 30 will define a reduced drop length generally corresponding to the maximum drop length of the covering 30 less the overall vertical height of the cells 58 forming the collapsed stack 140 (e.g., the cells 58 of the upper section 110 of the blanket 36) when such cells 58 are at the fully extended position. Thus, by knowing the vertical height of each cell 58 of the cellular blanket 36, the specific number of cells 58 to be collapsed or flattened down into the collapsed stack 140 may be selected to provide the desired drop length 52 for the covering 30.

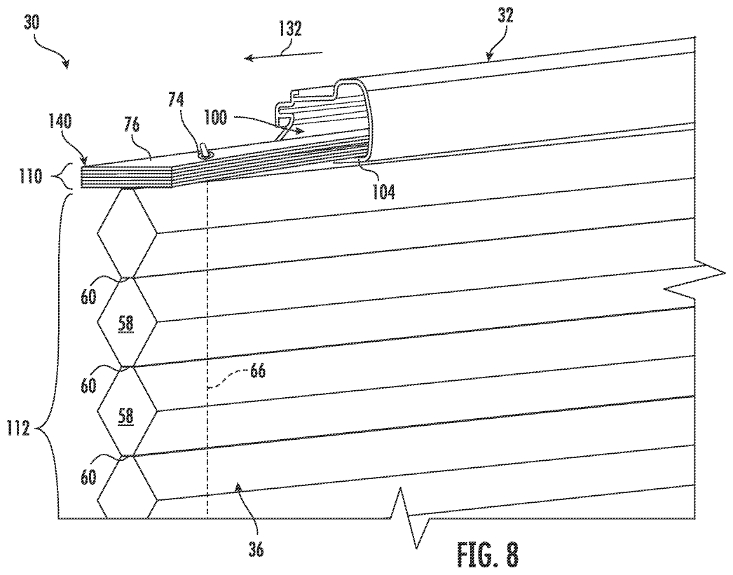

After forming the collapsed stack of cells 140 at the top end 76 of the cellular blanket 36, the method includes reassembling or res-installing the headrail 32 relative to the cellular blanket 36 such that the collapsed stack of cells 140 is received within the interior storage cavity 100 defined by the headrail 32. For example, FIG. 8 illustrates an example, partial view of the shortened cellular blanket 36 shown in FIG. 7 as the headrail 32 is being reinstalled relative to the blanket 36. Specifically, as shown, the headrail 32 is being moved or slid relative to the cellular blanket 36 in a second lateral direction (e.g., as indicated by arrow 132 in FIG. 8) such that the collapsed stack of cells 140 is received within the interior storage cavity 100 of the headrail 32 while the remainder of the cellular blanket 36 (e.g., the lower section 112 of the blanket 36) remains exterior to the headrail 32 to allow such portion of the blanket 36 to extend between the headrail 32 and the bottom rail 34. For instance, as the headrail 32 is being reinstalled relative to the cellular blanket 36, the bottom wall 104 of the headrail 32 may generally be slid or moved along the junction line 60 defined between the lowermost cell 58 of the collapsed stack of cells 140 and the next adjacent cell 58 positioned bellow the collapsed stack of cells 140 (e.g., the uppermost cell of the lower section 112 of the cellular blanket 36). Once the headrail 32 is fully assembled onto the cellular blanket 36, the reassembled covering 30 (having the adjusted drop length) may then be hung or installed relative to an architectural structure as desired.

While the foregoing Detailed Description and drawings represent various embodiments, it will be understood that various additions, modifications, and substitutions may be made therein without departing from the spirit and scope of the present disclosure. Each example is provided by way of explanation without intent to limit the broad concepts of the present disclosure. In particular, it will be clear to those skilled in the art that principles of the present disclosure may be embodied in other forms, structures, arrangements, proportions, and with other elements, materials, and components, without departing from the spirit or essential characteristics thereof. For instance, features illustrated or described as part of one embodiment can be used with another embodiment to yield a still further embodiment. Thus, it is intended that the present disclosure covers such modifications and variations as come within the scope of the appended claims and their equivalents. One skilled in the art will appreciate that the disclosure may be used with many modifications of structure, arrangement, proportions, materials, and components and otherwise, used in the practice of the disclosure, which are particularly adapted to specific environments and operative requirements without departing from the principles of the present disclosure. For example, elements shown as integrally formed may be constructed of multiple parts or elements shown as multiple parts may be integrally formed, the operation of elements may be reversed or otherwise varied, the size or dimensions of the elements may be varied. The presently disclosed embodiments are therefore to be considered in all respects as illustrative and not restrictive, the scope of the present disclosure being indicated by the appended claims, and not limited to the foregoing description.

It should also be understood that, as described herein, an “embodiment” (such as illustrated in the accompanying Figures) may refer to an illustrative representation of an environment or article or component in which a disclosed concept or feature may be provided or embodied, or to the representation of a manner in which just the concept or feature may be provided or embodied. However, such illustrated embodiments are to be understood as examples (unless otherwise stated), and other manners of embodying the described concepts or features, such as may be understood by one of ordinary skill in the art upon learning the concepts or features from the present disclosure, are within the scope of the disclosure. In addition, it will be appreciated that while the Figures may show one or more embodiments of concepts or features together in a single embodiment of an environment, article, or component incorporating such concepts or features, such concepts or features are to be understood (unless otherwise specified) as independent of and separate from one another and are shown together for the sake of convenience and without intent to limit to being present or used together. Independent concepts can be used in any configuration as may be appreciated by one ordinary skill in the art. For instance, concepts or features illustrated or described as part of one embodiment can be used separately, or with another embodiment to yield a still further embodiment. Thus, it is intended that the present disclosure covers such modifications and variations as come within the scope of the appended claims and their equivalents.

In the foregoing Detailed Description, it will be appreciated that the phrases “at least one”, “one or more”, and “and/or”, as used herein, are open-ended expressions that are both conjunctive and disjunctive in operation. The term “a” or “an” element, as used herein, refers to one or more of that element. As such, the terms “a” (or “an”), “one or more” and “at least one” can be used interchangeably herein. All directional references (e.g., proximal, distal, upper, lower, upward, downward, left, right, lateral, longitudinal, front, rear, top, bottom, above, below, vertical, horizontal, cross-wise, radial, axial, clockwise, counterclockwise, and/or the like) are only used for identification purposes to aid the reader's understanding of the present disclosure, and/or serve to distinguish regions of the associated elements from one another, and do not limit the associated element, particularly as to the position, orientation, or use of the present disclosure. Connection references (e.g., attached, coupled, connected, joined, secured, mounted and/or the like) are to be construed broadly and may include intermediate members between a collection of elements and relative movement between elements unless otherwise indicated. As such, connection references do not necessarily infer that two elements are directly connected and in fixed relation to each other. Identification references (e.g., primary, secondary, first, second, third, fourth, etc.) are not intended to connote importance or priority, but are used to distinguish one feature from another.

All apparatuses and methods disclosed herein are examples of apparatuses and/or methods implemented in accordance with one or more principles of the present disclosure. These examples are not the only way to implement these principles but are merely examples. Thus, references to elements or structures or features in the drawings must be appreciated as references to examples of embodiments of the present disclosure, and should not be understood as limiting the disclosure to the specific elements, structures, or features illustrated. Other examples of manners of implementing the disclosed principles will occur to a person of ordinary skill in the art upon reading this disclosure.

This written description uses examples to disclose the present disclosure, including the best mode, and also to enable any person skilled in the art to practice the present disclosure, including making and using any devices or systems and performing any incorporated methods. The patentable scope of the present disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

The following claims are hereby incorporated into this Detailed Description by this reference, with each claim standing on its own as a separate embodiment of the present disclosure. In the claims, the term “comprises/comprising” does not exclude the presence of other elements or steps. Furthermore, although individually listed, a plurality of means, elements or method steps may be implemented by, e.g., a single unit or processor. Additionally, although individual features may be included in different claims, these may possibly advantageously be combined, and the inclusion in different claims does not imply that a combination of features is not feasible and/or advantageous. In addition, singular references do not exclude a plurality. The terms “a”, “an”, “first”, “second”, etc., do not preclude a plurality. Reference signs in the claims are provided merely as a clarifying example and shall not be construed as limiting the scope of the claims in any way.

What is claimed is:

1. A covering for an architectural structure, the covering comprising:
a headrail including a first lateral end and a second lateral end opposite the first lateral end, the headrail defining an interior storage cavity extending in a lateral direction between the first and second lateral ends of the headrail;
a bottom rail suspended relative to the headrail; and
a cellular blanket coupled to the headrail and including an upper section and a lower section, the cellular blanket further including a plurality of vertically aligned cells, with a first portion of the plurality of vertically aligned cells being included within the upper section of the cellular blanket and a second portion of the plurality of vertically aligned cells being included within the lower section of the cellular blanket;
wherein:
the lower section of the cellular blanket extends between the headrail and the bottom rail such that the lower section of cellular blanket defines a drop length of the covering when in an extended position;
the upper section of the cellular blanket is received within the interior storage cavity of the headrail; and
a number of the plurality of vertically aligned cells included within the upper section of the cellular blanket is adjustable to vary the drop length of the covering when in the extended position.

2. The covering of claim 1, wherein the interior storage cavity of the headrail is sized such that the upper section of the cellular blanket is configured to include at least 20% of the plurality of vertically aligned cells of the cellular blanket.

3. The covering of claim 1, wherein the interior storage cavity of the headrail is sized such that the drop length of the covering is configured to be reduced by at least 20% of a maximum drop length of the cellular blanket depending on the number of the plurality of vertically aligned cells included within the upper section of the cellular blanket.

4. The covering of claim 1, wherein the headrail is configured to be decoupled from the cellular blanket to allow the number of the plurality of vertically aligned cells included within the upper section of the cellular blanket to be adjusted.

5. The covering of claim 4, wherein the headrail is configured to be decoupled from the cellular blanket by moving one of the headrail or the cellular blanket in the lateral direction relative to the other of the headrail or the cellular blanket.

6. The covering of claim 1, wherein the first portion of the plurality of vertically aligned cells included within the upper section of the cellular blanket are flattened into a collapsed stack of cells for receipt within the interior storage cavity of the headrail.

7. The covering of claim 1, wherein:
the headrail defines a downwardly facing slot extending laterally between the first and second lateral ends of the headrail; and
the cellular blanket extends through the downwardly facing slot such that the upper section of the cellular blanket is positioned within the interior storage cavity of the headrail and the lower section of the cellular blanket extends between the headrail and the bottom rail.

8. The covering of claim 1, further comprising a lift system including first and second lift cords extending between the headrail and the bottom rail and at least one lift system component positioned within the bottom rail, the lift system component being coupled to the first and second lift cords.

9. A covering for an architectural structure, the covering comprising:
first and second rails;
a cellular blanket extending between the first and second rails and including a first section and a second section, the cellular blanket further including a plurality of vertically aligned cells, with a first portion of the plurality of vertically aligned cells being included within the first section of the cellular blanket and a second portion of the plurality of vertically aligned cells being included within the second section of the cellular blanket;
wherein:
the first section of the cellular blanket is received within an interior storage cavity defined by the first rail;
the interior storage cavity is sized such that at least 20% of the plurality of vertically aligned cells of the cellular blanket are configured to be received therein;
the second section of the cellular blanket extends between the first and second rails such that the second section of the cellular blanket defines a drop length of the covering when in an extended position; and
a number of the plurality of vertically aligned cells included within the first section of the cellular blanket is adjustable to vary the drop length of the covering when in the extended position.

10. The covering of claim 9, wherein the first rail comprises a headrail of the covering and the second rail comprises a bottom rail of the covering.

11. The covering of claim 9, wherein the first rail comprises a bottom rail the covering and the second rail comprises a headrail of the covering.

12. The covering of claim 9, wherein the interior storage cavity of the first rail is sized such that the drop length of the covering can be reduced by at least 20% of a maximum drop length of the cellular blanket depending on the number of the plurality of vertically aligned cells included within the first section of the cellular blanket.

13. The covering of claim 9, wherein the first rail is configured to be decoupled from the cellular blanket to allow the number of the plurality of vertically aligned cells included within the first section of the cellular blanket to be adjusted.

14. The covering of claim 9, wherein the first portion of the plurality of vertically aligned cells included within the first section of the cellular blanket are flattened into a collapsed stack of cells for receipt within the interior storage cavity of the first rail

15. The covering of claim 9, wherein:
the first rail defines a slot extending laterally between the opposed lateral ends of the first rail; and
the cellular blanket extends through the slot such that the first section of the cellular blanket is positioned within the interior storage cavity of the first rail and the second section of the cellular blanket extends between the first and second rails.

16. The covering of claim 9, further comprising a lift system including first and second lift cords extending between the first and second rails and at least one lift system component positioned within the second rail, the lift system component being coupled to the first and second lift cords.

17. A method for adjusting a drop length of a covering for an architectural structure, the covering including a headrail, a bottom rail, and a cellular blanket, wherein an initial drop length of the covering is defined across a plurality of vertically aligned cells of the cellular blanket extending between the headrail and the bottom rail, the method comprising:
decoupling the headrail from the cellular blanket;
forming a collapsed stack of cells from a portion of the plurality of vertically aligned cells included within an upper section of the cellular blanket; and
reinstalling the headrail relative to the cellular blanket such that the collapsed stack of cells is received within an interior storage cavity of the headrail and a lower section of the cellular blanket including a remainder of the plurality of vertically aligned cells extends between the headrail and the bottom rail to define an adjusted drop length for the covering that differs from the initial drop length.

18. The method of claim 17, wherein the headrail extends in a lateral direction between opposed lateral ends of the headrail, wherein decoupling the headrail from the cellular blanket comprises moving one of the headrail or the cellular blanket in the lateral direction relative the other of the headrail or the cellular blanket.

19. The method of claim 17, wherein the headrail defines a downward facing slot extending in a lateral direction between opposed lateral ends of the headrail, wherein reinstalling the headrail relative to the cellular blanket comprises reinstalling the headrail relative to the cellular blanket such that the cellular blanket extends through the downward facing slot of the headrail, with the collapsed stack of cells being received within the interior storage cavity headrail and the lower section of the cellular blanket extending between the headrail and the bottom rail.

20. The method of claim 17, further comprising selecting a number of the plurality of vertically aligned cells to be included within the portion of the plurality of vertically aligned cells forming the collapsed stack of cells based on a desired drop length for the covering.
